(19) United States
(12) Patent Application Publication
(10) Pub. No.: US 2023/0254920 A1
(43) Pub. Date: Aug. 10, 2023

(54) METHOD AND DEVICE FOR TRANSMITTING/RECEIVING FRAME IN MULTI-LINK-SUPPORTING COMMUNICATION SYSTEM

(71) Applicants: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(72) Inventor: Yong Ho Kim, Incheon (KR)

(73) Assignees: HYUNDAI MOTOR COMPANY, Seoul (KR); KIA CORPORATION, Seoul (KR); KOREA NATIONAL UNIVERSITY OF TRANSPORTATION INDUSTRY-ACADEMIC COOPERATION FOUNDATION, Chungju-si (KR)

(21) Appl. No.: 18/012,179

(22) PCT Filed: Jun. 14, 2021
(86) PCT No.: PCT/KR2021/007380

§ 371 Date: Dec. 21, 2022

(30) Foreign Application Priority Data
Jun. 22, 2020 (KR) 10-2020-0076041

(51) Int. Cl. H04W 76/15; H04W 48/16; H04W 72/0453

(52) U.S. Cl. CPC H04W 76/15; H04W 48/16; H04W 72/0453

(57) ABSTRACT

A method and device are disclosed for transmitting/receiving a frame in a multi-link-supporting communication system. An operation method of a first device comprises the steps of: receiving a first beacon frame in a first link from a second device; carrying out a monitoring operation in a second link in order to receive a second beacon frame from the second device; and if the second beacon frame is not received in the second link, determining that the second link is in an unreachable state.

### CROSS-REFERENCE TO RELATED APPLICATIONS

This application is a U.S. national stage of International Application No. PCT/KR2021/007380, filed on Jun. 14, 2021, which claims priority from Korean Patent Application No. KR2020-0076041 filed on Jun. 22, 2020, the entire disclosures of which are incorporated by reference herein in its entirety.

### TECHNICAL FIELD

The present disclosure relates to a wireless local area network (LAN) communication technique, and more particularly, to a technique for transmission and reception of a frame in consideration of a transmission distance of radio waves in each of frequency bands.

### BACKGROUND

Recently, as the spread of mobile devices expands, a wireless local area network (LAN) technology capable of providing fast wireless communication services to mobile devices is in the spotlight. The wireless LAN technology may be a technology that supports mobile devices such as smart phones, smart pads, laptop computers, portable multimedia players, embedded devices, and the like to wirelessly access the Internet based on wireless communication technology.

The standards using the wireless LAN technology are being standardized as IEEE802.11 standards mainly in the Institute of Electrical and Electronics Engineers (IEEE). As the above-described wireless LAN technologies have been developed and spread, applications using the wireless LAN technologies have been diversified, and a demand for a wireless LAN technology supporting a higher throughput has arisen. Accordingly, a frequency bandwidth (e.g., ‘maximum 160 MHz bandwidth’ or ‘80+80 MHz bandwidth’) used in the IEEE 802.11ac standard has been expanded, and the number of supported spatial streams has also increased. The IEEE 802.11ac standard may be a very high throughput (VHT) wireless LAN technology supporting a high throughput of 1 gigabit per second (Gbps) or more. The IEEE 802.11ac standard can support downlink transmission for multiple stations by utilizing the multiple input multiple output (MIMO) techniques.

As applications requiring higher throughput and applications requiring real-time transmission occur, the IEEE 802.11be standard, which is an extreme high throughput (EHT) wireless LAN technology, is being developed. The goal of the IEEE 802.11be standard may be to support a high throughput of 30 Gbps. The IEEE 802.11be standard may support techniques for reducing a transmission latency. In addition, the IEEE 802.11be standard can support a more expanded frequency bandwidth (e.g., 320 MHz bandwidth), multi-link transmission and aggregation operations including multi-band operations, multiple access point (AP) transmission operations, and/or efficient retransmission operations (e.g., hybrid automatic repeat request (HARQ) operations).

However, since multi-link operations are operations not defined in the existing wireless LAN standard, it may be necessary to define detailed operations according to an environment in which the multi-link operations are performed. In particular, a multi-link may be configured in different frequency bands, and a transmission distance of radio waves in each of the different frequency bands may vary. When the same transmission power is used in the multi-link, communication in a specific link may not be performed.

The technologies that are the background of the present disclosure are written to improve the understanding of the background of the present disclosure and may include content that is not already known to those of ordinary skill in the art to which the present disclosure belongs.

### SUMMARY

### Technical Problem

The present disclosure is directed to providing a method and an apparatus for transmission and reception of a frame in consideration of a transmission distance of radio waves in each of frequency bands.

### Technical Solution

An operation method of a first device, according to a first embodiment of the present disclosure for achieving the above-described objective, may comprise: receiving a first beacon frame from a second device in a first link; performing a monitoring operation in a second link to receive a second beacon frame from the second device; and determining that the second link is in an unreachable state when the second beacon frame is not received in the second link. A first frequency band in which the first link is configured is different from a second frequency band in which the second link is configured, and a transmission distance of radio waves in the first frequency band is longer than a transmission distance of radio waves in the second frequency band.

The first beacon frame may include at least one of information indicating that the second link is available or information on a transmission power in the second link.

The operation method may further comprise: in response to determining that the second link is in the unreachable state, transmitting a first probe request frame in the first link; and transmitting a second probe request frame in the second link. The first probe request frame may include at least one of information indicating the first link in which the first probe request frame is transmitted or information indicating the second link in which the second probe request frame is transmitted.

The determining that the second link is in the unreachable state may comprise: transmitting a reachability check request frame in the second link; and determining that the second link is in the unreachable state when a response frame to the reachability check request frame is not received in the second link.

The reachability check request frame may have a form of a quality of service (QoS) null frame or a power saving (PS)-Poll frame.

The operation method may further comprise configuring a multi-link with the second device, the second link in the unreachable state being excluded from the multi-link.

Each of the first beacon frame and the second beacon frame may include at least one of information on a maximum transmission power in the first link, information on a number of repeated transmissions in the first link, information on a maximum transmission power in the second link, information on a number of repeated transmissions in the second link, or combinations thereof.

The operation method may further comprise: in response to determining that the second link is in the unreachable state, performing communication with the second device using a first transmission power in the first link; and performing communication with the second device using a second transmission power in the second link, wherein the second transmission power is greater than the first transmission power.

The operation method may further comprise: in response to determining that the second link is in the unreachable state, performing communication with the second device in the first link without repeated transmissions of a frame; and performing communication with the second device in the second link by repeatedly transmitting a frame.

An operation method of a first device, according to a second embodiment of the present disclosure for achieving the above-described objective, may comprise: receiving a first beacon frame from a second device in a first link; receiving a second beacon frame from the second device in the first link; comparing a first reception quality of the first beacon frame with a second reception quality of the second beacon frame; and performing a reachability check operation in a second link based on a result of the comparison between the first reception quality and the second reception quality.

Each of the first beacon frame and the second beacon frame may include at least one of information on a transmission power in the first link, information on a transmission power in the second link, information on a difference between the transmission power in the first link and the transmission power in the second link, or combinations thereof.

The reachability check operation may be performed when the second reception quality is higher than the first reception quality.

The reachability check operation may be performed when the second reception quality is higher than (the first reception quality+an offset), and the offset is included in at least one of the first beacon frame and the second beacon frame.

The performing of the reachability check operation may comprise: transmitting a reachability check request frame in the second link; receiving a reachability check response frame in the second link as a response to the reachability check request frame; and determining that the second link is available when the reachability check response frame is received.

The operation method may further comprise configuring a multi-link including the available second link with the second device.

The reachability check request frame may have a form of a quality of service (QoS) null frame or a power saving (PS)-Poll frame.

An operation method of a second device, according to a third embodiment of the present disclosure for achieving the above-described objective, may comprise: generating a first frame including information indicating a number of repeated transmissions in a second link; transmitting the first frame to a first device in a first link; and in response to determining that a second frame is unreachable in the second link, repeatedly transmitting the second frame to the first device in the second link as many times as the number of repeated transmissions indicated by the first frame.

The operation method may further comprise, when a third frame is reachable in the first link, transmitting the third frame to the first device in the first link without repeated transmissions.

The first frame may further include information indicating a second transmission power in the second link, and the second frame may be transmitted using the second transmission power indicated by the first frame.

The first frame may further include information indicating a first transmission power in the first link, wherein the first transmission power is lower than the second transmission power.

### Advantageous Effects

According to the present disclosure, a communication node (e.g., AP, STA, or a multi-link device (MLD)) may determine whether frame transmission/reception is possible in a first link. When it is impossible to transmit and receive frames in the first link, the communication node may release the first link from a multi-link. When frames can be transmitted and received in the first link, the communication node may configure a multi-link including the first link and perform communication using the multi-link. Therefore, communication efficiency in the wireless LAN system can be improved.

### DESCRIPTION OF DRAWINGS

FIG. 1 is a block diagram illustrating a first embodiment of a communication node constituting a wireless local area network (LAN) system.

FIG. 2 is a conceptual diagram illustrating a first embodiment of multi-links configured between multi-link devices (MLDs).

FIG. 3 is a sequence chart illustrating a first embodiment of a negotiation procedure for a multi-link operation in a wireless LAN system.

FIG. 4 is a conceptual diagram illustrating a first embodiment of a communication method based on frequency characteristics of a multi-link in a wireless LAN system.

FIG. 5 is a sequence chart illustrating a first embodiment of a method for determining a link capable of communication in a wireless LAN system.

FIG. 6 is a sequence chart illustrating a second embodiment of a method for determining a link capable of communication in a wireless LAN system.

FIG. 7 is a sequence chart illustrating a third embodiment of a method for determining a link capable of communication in a wireless LAN system.

FIG. 8 is a sequence chart illustrating a first embodiment of an association method in a wireless LAN system.

FIG. 9 is a block diagram illustrating a first embodiment of a reachability check request frame.

FIG. 10 is a block diagram illustrating a second embodiment of a reachability check request frame.

### DETAILED DESCRIPTION

Since the present disclosure may be variously modified and may have several forms, specific embodiments are shown in the accompanying drawings and be described in the detailed description. It should be understood, however, that it is not intended to limit the present disclosure to the specific embodiments. On the contrary, the present disclosure is intended to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it should be understood that a further component is not disposed therebetween.

The terms used in the present disclosure are only used to describe specific embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure are described in detail with reference to the accompanying drawings. In describing the disclosure, to facilitate the entire understanding of the disclosure, like numbers refer to like elements throughout the description of the figures and the repetitive description thereof has been omitted.

In the following, a wireless communication system to which embodiments according to the present disclosure are applied is described. The wireless communication system to which the embodiments according to the present disclosure are applied is not limited to the contents described below, and the embodiments according to the present disclosure can be applied to various wireless communication systems. A wireless communication system may be referred to as a ‘wireless communication network’.

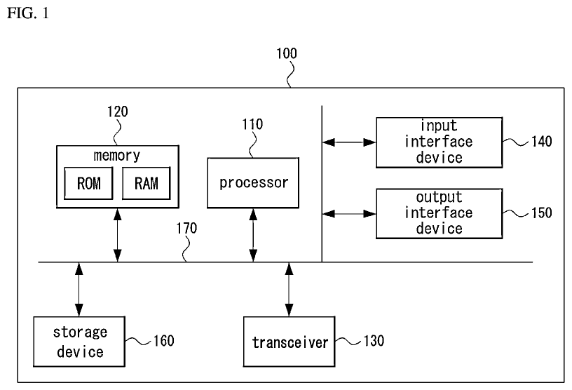

FIG. 1 is a block diagram illustrating a first embodiment of a communication node constituting a wireless local area network (LAN) system.

As shown in FIG. 1, a communication node 100 may be an access point, a station, an access point (AP) multi-link device (MLD), or a non-AP MLD. The access point may refer to an AP, and the station may refer to a STA or a non-AP STA. The operating channel width supported by the access point may be 20 megahertz (MHz), 80 MHz, 160 MHz, or the like. The operating channel width supported by the station may be 20 MHz, 80 MHz, or the like.

The communication node 100 may include at least one processor 110, a memory 120, and a plurality of transceivers 130 connected to a network to perform communications. The transceiver 130 may be referred to as a transceiver, a radio frequency (RF) unit, an RF module, or the like. In addition, the communication node 100 may further include an input interface device 140, an output interface device 150, a storage device 160, and the like. The components included in the communication node 100 may be connected by a bus 170 to communicate with each other.

However, the respective components included in the communication node 100 may be connected through individual interfaces or individual buses centering on the processor 110 instead of the common bus 170. For example, the processor 110 may be connected to at least one of the memory 120, the transceiver 130, the input interface device 140, the output interface device 150, or the storage device 160 through a dedicated interface.

The processor 110 may execute at least one instruction stored in at least one of the memory 120 or the storage device 160. The processor 110 may refer to a central processing unit (CPU), a graphics processing unit (GPU), or a dedicated processor on which the methods according to the embodiments of the present disclosure are performed. Each of the memory 120 and the storage device 160 may be configured as at least one of a volatile storage medium or a nonvolatile storage medium. For example, the memory 120 may be configured with at least one of a read only memory (ROM) or a random-access memory (RAM).

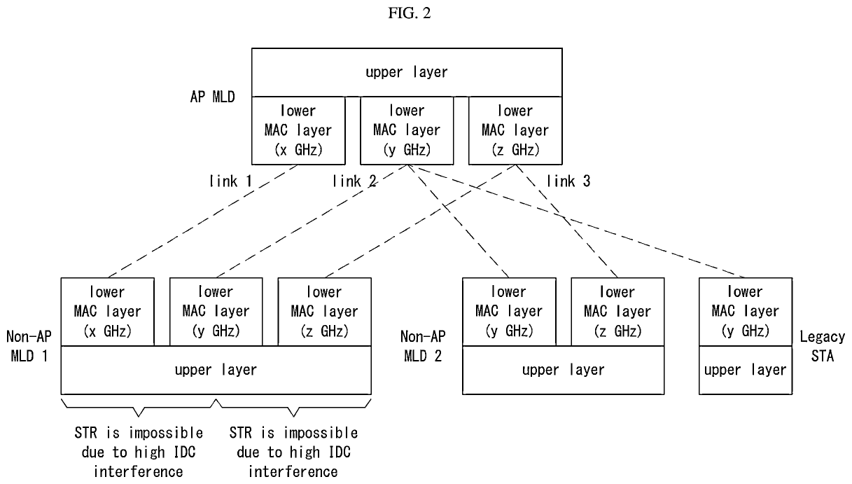

FIG. 2 is a conceptual diagram illustrating a first embodiment of multi-links configured between MLDs.

As shown in FIG. 2, an MLD may have one medium access control (MAC) address. In embodiments, the MLD may mean an AP MLD and/or non-AP MLD. The MAC address of the MLD may be used in a multi-link setup procedure between the non-AP MLD and the AP MLD. The MAC address of the AP MLD may be different from the MAC address of the non-AP MLD. AP(s) affiliated with the AP MLD may have different MAC addresses, and station(s) (STA(s)) affiliated with the non-AP MLD may have different MAC addresses. Each of the APs having different MAC addresses may be in charge of each link among multiple links supported by the AP MLD, and may perform a role of an independent AP.

Each of the STAs having different MAC addresses may be in charge of each link among multiple links supported by the non-AP MLD, and may perform a role of an independent STA. The non-AP MLD may be referred to as a STA MLD. The MLD may support a simultaneous transmit and receive (STR) operation. In this case, the MLD may perform a transmission operation in a link 1 and may perform a reception operation in a link 2. The MLD supporting the STR operation may be referred to as an STR MLD (e.g., STR AP MLD, STR non-AP MLD). In embodiments, a link may mean a channel or a band. A device that does not support the STR operation may be referred to as a non-STR (NSTR) AP MLD or an NSTR non-AP MLD (or NSTR STA MLD).

The MLD may transmit and receive frames in multiple links (i.e., multi-link) by using a non-contiguous bandwidth extension scheme (e.g., 80 MHz+80 MHz). The multi-link operation may include multi-band transmission. The AP MLD may include a plurality of APs, and the plurality of APs may operate in different links. Each of the plurality of APs may perform function(s) of a lower MAC layer. Each of the plurality of APs may be referred to as a ‘communication node’ or ‘lower entity’. The communication node (i.e., AP) may operate under control of an upper layer (or the processor 110 shown in FIG. 1). The non-AP MLD may include a plurality of STAs, and the plurality of STAs may operate in different links. Each of the plurality of STAs may be referred to as a ‘communication node’ or ‘lower entity’. The communication node (i.e., STA) may operate under control of an upper layer (or the processor 110 shown in FIG. 1).

The MLD may perform communications in multiple bands (i.e., multi-band). For example, the MLD may perform communications using an 80 MHz bandwidth according to a channel expansion scheme (e.g., bandwidth expansion scheme) in a 2.4 GHz band, and may perform communications using a 160 MHz bandwidth according to a channel expansion scheme in a 5 GHz band. The MLD may perform communications using a 160 MHz bandwidth in the 5 GHz band, and may perform communications using a 160 MHz bandwidth in a 6 GHz band. One frequency band (e.g., one channel) used by the MLD may be defined as one link. Alternatively, a plurality of links may be configured in one frequency band used by the MLD. For example, the MLD may configure one link in the 2.4 GHz band and two links in the 6 GHz band. The respective links may be referred to as a first link, a second link, and a third link. Alternatively, the respective links may be referred to as a link 1, a link 2, and a link 3. A link number may be set by the AP, and an identifier (ID) may be assigned to each link.

The MLD (e.g., AP MLD and/or non-AP MLD) may configure a multi-link by performing an access procedure and/or a negotiation procedure for a multi-link operation. In this case, the number of links and/or link(s) to be used in the multi-link may be configured. The non-AP MLD (e.g., STA) may identify information on band(s) capable of communicating with the AP MLD. In the negotiation procedure for a multi-link operation between the non-AP MLD and the AP MLD, the non-AP MLD may configure one or more links among links supported by the AP MLD to be used for the multi-link operation. A station that does not support a multi-link operation (e.g., IEEE 802.11a/b/g/n/ac/ax STA) may be connected to one or more links of the multi-link supported by the AP MLD.

When a band separation between multiple links (e.g., a band separation between the link 1 and the link 2 in the frequency domain) is sufficient, the MLD may perform an STR operation. For example, the MLD may transmit a physical layer convergence procedure (PLCP) protocol data unit (PPDU) 1 using the link 1 among multiple links and may receive a PPDU 2 using the link 2 among multiple links. On the other hand, if the MLD performs the STR operation when the band separation between multiple links is insufficient, in-device coexistence (IDC) interference, which is interference between the multiple links, may occur. Therefore, when the band separation between multiple links is not sufficient, the MLD may not be able to perform the STR operation.

For example, a multi-link including a link 1, a link 2, and a link 3 may be configured between the AP MLD and the non-AP MLD 1. If the band separation between the link 1 and the link 3 is sufficient, the AP MLD may perform an STR operation using the link 1 and the link 3. In other words, the AP MLD may transmit a frame using the link 1 and may receive a frame using the link 3. If the band separation between the link 1 and the link 2 is not sufficient, the AP MLD may not be able to perform an STR operation using the link 1 and the link 2. If a band separation between the link 2 and the link 3 is not sufficient, the AP MLD may not be able to perform an STR operation using the link 2 and the link 3.

In a wireless LAN system, a negotiation procedure for a multi-link operation may be performed in an access procedure between a STA and an AP.

A device (e.g., AP or STA) supporting a multi-link may be referred to as a multi-link device (MLD). An AP supporting a multi-link may be referred to as an AP MLD, and a STA supporting a multi-link may be referred to as a non-AP MLD or STA MLD. The AP MLD may have a physical address (e.g., MAC address) for each link. The AP MLD may be implemented as if an AP in charge of each link exists separately. A plurality of APs may be managed within one AP MLD. Accordingly, coordination between the plurality of APs belonging to the same AP MLD may be possible. The STA MLD may have a physical address (e.g., MAC address) for each link. The STA MLD may be implemented as if an STA in charge of each link exists separately. A plurality of STAs may be managed within one STA MLD. Accordingly, coordination between the plurality of STAs belonging to the same STA MLD may be possible.

For example, an AP1 of the AP MLD and a STA1 of the STA MLD may each be in charge of a first link and may communicate using the first link. An AP2 of the AP MLD and a STA2 of the STA MLD may each be in charge of a second link and may communicate using the second link. The STA2 may receive state change information for the first link in the second link. In this case, the STA MLD may collect information (e.g., state change information) received from each link, and may control operations performed by the STA1 based on the collected information.

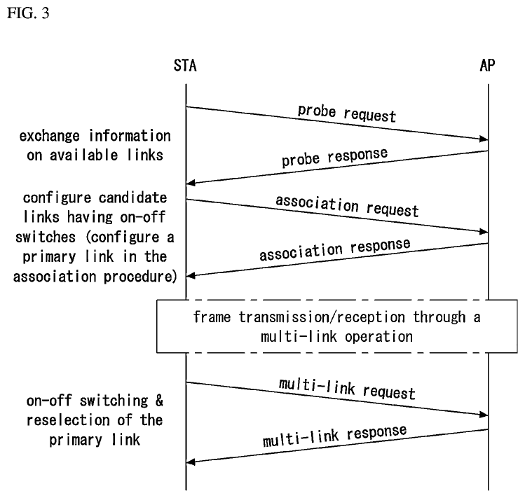

FIG. 3 is a sequence chart illustrating a first embodiment of a negotiation procedure for a multi-link operation in a wireless LAN system.

As shown in FIG. 3 an access procedure between an STA and an AP in an infrastructure basic service set (BSS) may generally be divided into a probe step of probing AP(s), an authentication step for authentication between the STA and the probed AP, and an association step of association between the STA and the authenticated AP.

In the probe step, the STA may detect one or more APs using a passive scanning scheme or an active scanning scheme. When the passive scanning scheme is used, the STA may detect one or more APs by overhearing beacons transmitted by the one or more APs. When the active scanning scheme is used, the STA may transmit a probe request frame and may detect one or more APs by receiving probe response frames that are responses to the probe request frame from the one or more APs.

When the one or more APs are detected, the STA may perform an authentication step with the detected AP(s). In this case, the STA may perform the authentication step with a plurality of APs. An authentication algorithm according to the IEEE 802.11 standard may be classified into an open system algorithm of exchanging two authentication frames, a shared key algorithm of exchanging four authentication frames, and the like.

The STA may transmit an authentication request frame based on the authentication algorithm according to the IEEE 802.11 standard, and may complete authentication with the AP by receiving an authentication response frame that is a response to the authentication request frame from the AP.

When the authentication with the AP is completed, the STA may perform an association step with the AP. In particular, the STA may select one AP among AP(s) with which the STA has performed the authentication step and may perform the association step with the selected AP. In other words, the STA may transmit an association request frame to the selected AP and may complete the association with the AP by receiving an association response frame that is a response to the association request frame from the selected AP.

A multi-link operation may be supported in the wireless LAN system. A multi-link device (MLD) may include one or more STAs affiliated with the MLD. The MLD may be a logical entity. The MLD may be classified into an AP MLD and a non-AP MLD. Each STA affiliated with the AP MLD may be an AP, and each STA affiliated with the non-AP MLD may be a non-AP STA. In order to configure a multi-link, a multi-link discovery procedure, a multi-link setup procedure, and the like may be performed. The multi-link discovery procedure may be performed in the probe step between an STA and an AP. In this case, multi-link information elements (ML IEs) may be included in the beacon frame, the probe request frame, and/or the probe response frame.

For example, in order to perform a multi-link operation, in the probe step, the AP (e.g., AP affiliated with an MLD) may exchange information indicating whether the multi-link operation can be used and information on available link(s) with the STA (e.g., non-AP STA affiliated with an MLD). In a negotiation procedure for the multi-link operation (e.g., multi-link setup procedure), the STA may transmit information of link(s) to be used for the multi-link operation. The negotiation procedure for the multi-link operation may be performed in the access procedure (e.g., association step) between the STA and the AP, and information element(s) required for the multi-link operation may be configured or changed by an action frame in the negotiation procedure.

In addition, in the access procedure (e.g., association step) between the STA and the AP, available link(s) of the AP may be configured, and an identifier (ID) may be assigned to each link. Thereafter, in the negotiation procedure and/or change procedure for the multi-link operation, information indicating whether each link is activated may be transmitted, and the information may be expressed using the link ID(s).

The information indicating whether the multi-link operation can be used may be transmitted and received in a procedure of exchanging capability information element(s) (e.g., EHT capability information element(s)) between the STA and the AP. The capability information element(s) may include information of supporting band(s), information of supporting link(s) (e.g., ID(s) and/or number of supporting link(s)), information of links capable of simultaneous transmission and reception (STR) operations (e.g., information on bands of the links, information on a separation between the links), and/or the like. In addition, the capability information element(s) may include information that individually indicates a link capable of the STR operation.

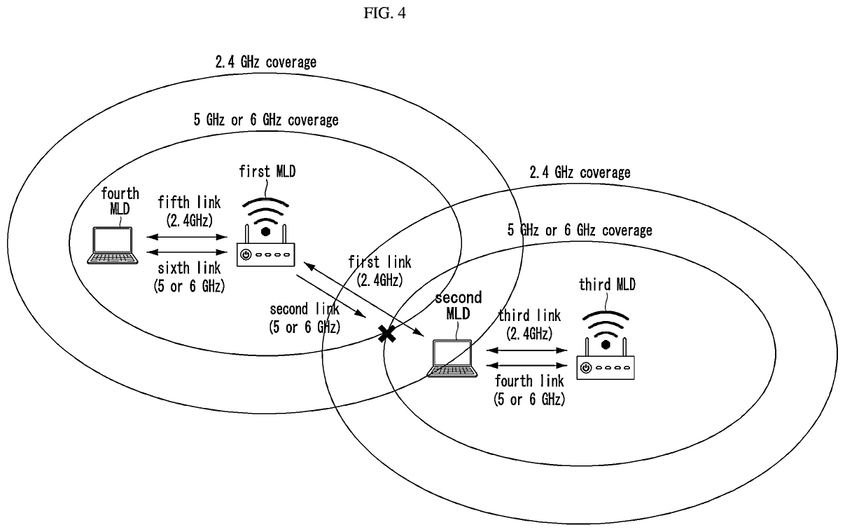

FIG. 4 is a conceptual diagram illustrating a first embodiment of a communication method based on frequency characteristics of a multi-link in a wireless LAN system.

As shown in FIG. 4, a first MLD (e.g., AP MLD) may simultaneously transmit and receive frames (e.g., data) with a second MLD (e.g., non-AP MLD) using a multi-link. The multi-link may include a first link and a second link. A frequency band of the first link may be different from that of the second link. For example, the frequency band of the first link may be a 2.4 GHz band and the frequency band of the second link may be a 5 GHz band or 6 GHz band. When the same transmission power is used, transmission distances of radio waves in the frequency bands may be different. The transmission distance (e.g., transmission area, reachable area, or reachable distance) of radio waves in the 2.4 GHz band may be different from the transmission distance of radio waves in the 5 GHz band or 6 GHz band. For example, the transmission distance of radio waves in the 2.4 GHz band may be longer than the transmission distance of radio waves in the 5 GHz band or 6 GHz band.

A multi-link configuration operation between the first MLD and the second MLD may be performed using one link in the multi-link, and the one link may be referred to as a primary link. The frequency band usable in the multi-link may be the 2.4 GHz band, 5 GHz band, or 6 GHz band. The transmission distance of radio waves may be shortened as the frequency increases. When the same transmission power is used, the transmission distance of radio waves may be the longest in a link using the 2.4 GHz band.

When the multi-link configuration operation is performed in the first link of the 2.4 GHz band, the second link of the 5 GHz band or 6 GHz band is used together with the first link, and the same transmission power is used in the multi-link (e.g., first link and second link), a link in which communication is impossible may occur depending on a location of the second MLD. For example, communication between the first MLD and the second MLD may be performed in the first link, but communication between the first MLD and the second MLD may be impossible in the second link.

A multi-link may be configured between the second MLD and a third MLD (e.g., AP MLD), and the multi-link may include a third link and a fourth link. The third link may be configured in the 2.4 GHz band and the fourth link may be configured in the 5 GHz band or 6 GHz band. Communication between the second MLD and the third MLD may be performed in the third link and communication between the second MLD and the third MLD may also be performed in the fourth link. In other words, the second MLD may be located within a communication area with the third MLD. The communication between the first MLD and the second MLD in the first link and the communication between the second MLD and the third MLD in the fourth link may be simultaneously performed.

A channel on which the first link is configured may be different from a channel on which the third link is configured within the 2.4 GHz band. The operating link between the second MLD and the third MLD may be changed from the fourth link to the third link. In this case, the communication between the first MLD and the second MLD in the first link and the communication between the second MLD and the third MLD in the third link may be simultaneously performed.

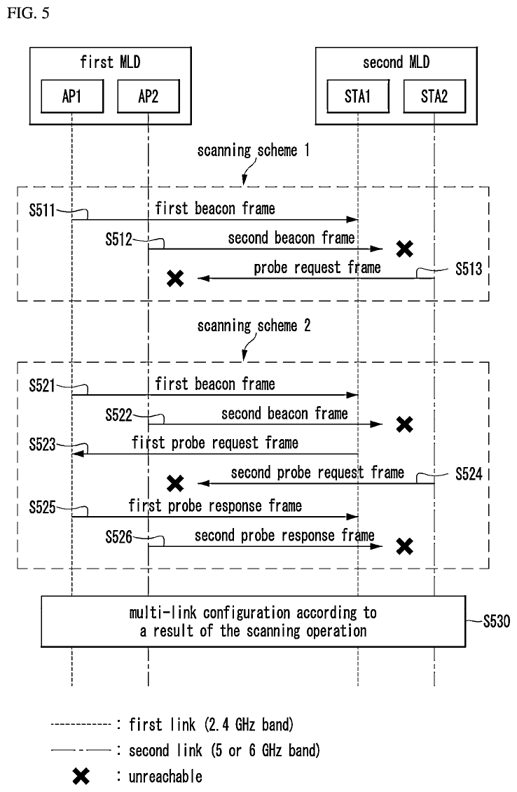

FIG. 5 is a sequence chart illustrating a first embodiment of a method for determining a link capable of communication in a wireless LAN system.

As shown in FIG. 5, a wireless LAN system may include a first MLD and a second MLD. The first MLD may be an AP MLD and may include an AP1 and an AP2. The second MLD may be a non-AP MLD and may include a STA1 and a STA2. Each of the AP1 and the STA1 may perform communication using a first link. A frequency band of the first link may be 2.4 GHz. Each of the AP2 and the STA2 may perform communication using a second link. A frequency band of the second link may be 5 GHz or 6 GHz.

Each of the first MLD and the second MLD may support a multi-link (e.g., first link and second link). The AP1 and AP2 included in the first MLD may have different MAC addresses, and the STA1 and STA2 included in the second MLD may have different MAC addresses. In an access procedure between the first MLD and the second MLD, the second MLD may perform a scanning operation to discover the first MLD. The scanning operation may be performed according to a scanning scheme 1 or scanning scheme 2.

Scanning Scheme 1 (Steps S511 to S513)

The AP1 may transmit a first beacon frame in the first link (S511). The first beacon frame transmitted by the AP1 in the first link may include information on the AP2, information on the second link, and/or information on a transmission power of the AP2. The information on the AP2 may indicate that the second link is available. In other words, the information on the AP2 may indicate information on an available multi-link and information on whether a multi-link is supported. The information on the transmission power of the AP2 may indicate a transmission power of a frame (e.g., beacon frame) transmitted by the AP2 in the second link. The information on the transmission power of the AP2, which is included in the first beacon frame of the AP1, may be a value normalized to 20 MHz. The information on the transmission power of the AP2 may indicate a difference between a beacon transmission power (e.g., effective radiated power (EIRP)) of the first beacon frame currently transmitted by the AP1 through a 20 MHz channel and the transmission power of the AP2. The STA1 may receive the first beacon frame from the AP1 in the first link and may identify information element(s) included in the first beacon frame. For example, the second MLD (e.g., STA1) may determine that the second link is supported based on the information on the AP2 and/or the information on the second link included in the first beacon frame. The information on the AP2 and/or the information on the second link may be transmitted in a form including information on the multi-link.

The STA1 may transmit a probe request frame requesting multi-link information in the first link, and a probe response frame transmitted by the AP1 in the first link may include information on the AP2, information on the second link, and/or information on the transmission power of the AP2, which are included in the first beacon frame. The information on the AP2 may indicate that the second link is available. The AP2 may transmit a second beacon frame in the second link (S512). The second beacon frame transmitted by the AP2 in the second link may include information on the AP1, information on the first link, and/or information on the transmission power of the AP1. The information on the AP1 may indicate that the first link is available. In other words, the information on the AP1 may indicate information on an available multi-link or information whether a multi-link is supported. The information on the transmission power of the AP1 may indicate a transmission power of a frame (e.g., beacon frame) transmitted by the AP1 in the first link. The information on the transmission power of the AP1, which is included in the second beacon frame of the AP2, may be a value normalized to 20 MHz. The information on the transmission power of the AP1 may indicate a difference between a beacon transmission power (e.g., EIRP) of the second beacon frame currently transmitted by the AP2 through a 20 MHz channel and the transmission power of the AP1.

The STA2 may perform a monitoring operation in the second link to receive the second beacon frame. The monitoring operation in the second link may be performed when it is determined that the second link is supportable. That the second link is supportable may be determined based on the information on the AP2, the information on the second link, and/or the information on the transmission power of the AP2, which are included in the first beacon frame. Since the frequency characteristic of the second link is different from that of the first link, the STA2 may not receive the second beacon frame in the second link. Although the second link is indicated by the first beacon frame to be supportable, if it is determined that radio waves cannot be received as a result of calculation (e.g., pathloss calculation according to a channel model) on whether radio waves can be received according to a frequency by referring to the information on the transmission power of the AP2 and a reception power of the first beacon frame, or if the second beacon frame is not received in the second link, the second MLD (e.g., STA2) may determine that communication is impossible in the second link. For example, the second MLD may determine that the first link is in a reachable state and may determine that the second link is in an unreachable state.

The STA2 may transmit a probe request frame requesting multi-link information in the second link (S513). The step S513 may be performed before reception of the second beacon frame or after knowing whether the second link is supportable. Depending on the link characteristics, the AP2 may or may not receive the probe request frame transmitted from the STA2.

If the AP2 receives the probe request frame transmitted from the STA2, the AP2 may transmit a probe response frame. The probe response frame transmitted by the AP2 in the second link may include information on the AP1, information on the first link, and/or information on the transmission power of the APE The information on the AP1 may indicate that the first link is available.

The AP2 may not receive the probe request frame of the STA2 in the second link. In this case, the AP2 may not transmit a probe response frame, which is a response to the probe request frame, in the second link. Therefore, the STA2 may not receive the probe response frame of the AP2 in the second link. When the probe response frame is not received in the second link, the second MLD (e.g., STA2) may determine that the second link is in an unreachable state.

Scanning Scheme 2 (Step S521 to Step S526)

The AP1 may transmit a first beacon frame in the first link (S511). The first beacon frame transmitted by the AP1 in the first link may include information on the AP2, information on the second link, and/or information on a transmission power of the AP2. The information on the AP2 may indicate that the second link is available. In other words, the information on the AP2 may indicate information on an available multi-link and information on whether a multi-link is supported. The information on the transmission power of the AP2 may indicate a transmission power of a frame (e.g., beacon frame) transmitted by the AP2 in the second link. The information on the transmission power of the AP2 included in the first beacon frame of the AP1 may be a value normalized to 20 MHz. The information on the transmission power of the AP2 may indicate a difference between a beacon transmission power (e.g., EIRP) of the first beacon frame currently transmitted by the AP1 through a 20 MHz channel and the transmission power of the AP2. The STA1 may receive the first beacon frame from the AP1 in the first link and may identify information element(s) included in the first beacon frame. For example, the second MLD (e.g., STA1) may determine that the second link is supported based on the information on the AP2 and/or the information on the second link included in the first beacon frame. The information on the AP2 and/or the information on the second link may be transmitted in a form including information on the multi-link.

The AP2 may transmit a second beacon frame in the second link (S522). The STA2 may perform a monitoring operation in the second link to receive the second beacon frame. The monitoring operation in the second link may be performed when it is determined that the second link is supportable. That the second link is supportable may be determined based on the information on the AP2 and/or the information on the second link included in the first beacon frame. Since the frequency characteristic of the second link is different from that of the first link, the STA2 may not receive the second beacon frame in the second link. Although the second link is indicated by the first beacon frame to be supportable, if it is determined that radio waves cannot be received as a result of calculation (e.g., pathloss calculation according to a channel model) on whether radio waves can be received according to a frequency by referring to the information on the transmission power of the AP2 and a reception power of the first beacon frame, or if the second beacon frame is not received in the second link, the second MLD (e.g., STA2) may determine that communication is impossible in the second link. For example, the second MLD may determine that the first link is in a reachable state and may determine that the second link is in an unreachable state.

The STA1 may transmit a first probe request frame requesting multi-link information in the first link (S523). The STA2 may transmit a second probe request frame requesting multi-link information in the second link (S524). The steps S523 and S524 may be performed simultaneously. The first probe request frame may include a multi-link indicator, which is information on the links (e.g., first link and second link) in which the probe request frames are simultaneously transmitted. The second probe request frame may include a multi-link indicator, which is information on the links (e.g., first link and second link) in which the probe request frames are simultaneously transmitted. The steps S523 and/or S524 may be performed before reception of the second beacon frame or after it is determined that the second link is supportable. That the second link is supportable may mean that the second link is indicated to be supportable by the first beacon frame received in the first link.

The AP1 may receive the first probe request frame from the STA1 in the first link and may not receive the second probe request frame from the STA2 in the second link. The first MLD (e.g., AP1) may identify that the probe request frames are simultaneously transmitted in the first link and the second link based on the multi-link indicator (e.g., link identifiers or link indexes) included in the first probe request frame. When the probe request frames are simultaneously transmitted in the first link and the second link, but the second probe request frame is not received in the second link, the first MLD (e.g., AP1 and/or AP2) may determine that the second link is in an unreachable state. If the multi-link indicator is included in the probe request frame, it may be determined that information on an AP in charge of another link and/or information on a link (e.g., link information including transmission power information) is requested.

When the first probe request frame is received in the first link, the AP1 may transmit a first probe response frame in the first link as a response to the first probe request frame (S525). Referring to the multi-link indicator included in the first probe request frame, the first probe response frame may include information indicating that the second probe request frame is not received in the second link. For example, the first probe response frame may indicate that the second link is in an unreachable state.

When the AP1 transmits the first beacon frame in the first link, the information on the AP2, information on the second link, and/or information on the transmission power of the AP2, which are included in the first beacon frame, may be transmitted also through the first probe response frame transmitted in the first link. The information on the transmission power of the AP2 may be included in the first probe response frame as information indicating that the second probe request frame is not received in the second link. The information on the transmission power of the AP2 may be a value normalized to 20 MHz. The information on the transmission power of the AP2 may indicate a difference between a beacon transmission power (e.g., EIRP) of the first beacon frame currently transmitted by the AP1 through a 20 MHz channel and the transmission power of the AP2.

The STA1 may receive the first probe response frame from the AP1 in the first link. The second MLD (e.g., STA1 and/or STA2) may determine that the second link is in an unreachable state based on the information (e.g., information on the transmission power) included in the first probe response frame.

When the second probe request frame is not received in the second link, the AP2 may not transmit the second probe response frame, which is a response to the second probe request frame, in the second link. In this case, the STA2 may not receive the second probe response frame in the second link. Accordingly, the second MLD (e.g., STA2) may determine that the second link is in an unreachable state. In other words, when the first probe response frame is received only in the first link of the multi-link, the second MLD (e.g., STA2) may determine that the second link is in an unreachable state.

Alternatively, even when the second probe request frame is not received in the second link, the AP2 may transmit the second probe response frame in the second link (S526). When the AP2 transmits the second beacon frame in the second link, the information on the AP1, information on the first link, and/or information on the transmission power of the AP1, which are included in the second beacon frame, may be included in the second probe response frame transmitted in the second link. Since the second probe response frame of the AP2 does not reach the STA2, the STA2 may not receive the second probe response frame in the second link. Accordingly, the second MLD (e.g., STA2) may determine that the second link is in an unreachable state.

The first MLD and the second MLD may configure a multi-link to be used for communication excluding a link in an unreachable state based on a result of the scanning operation (e.g., operation according to the scanning scheme 1 or operation according to the scanning scheme 2) (S530). For example, when the second link is in an unreachable state, the first MLD and the second MLD may configure a multi-link excluding the second link. The multi-link configured between the first MLD and the second MLD may include the first link in a reachable state.

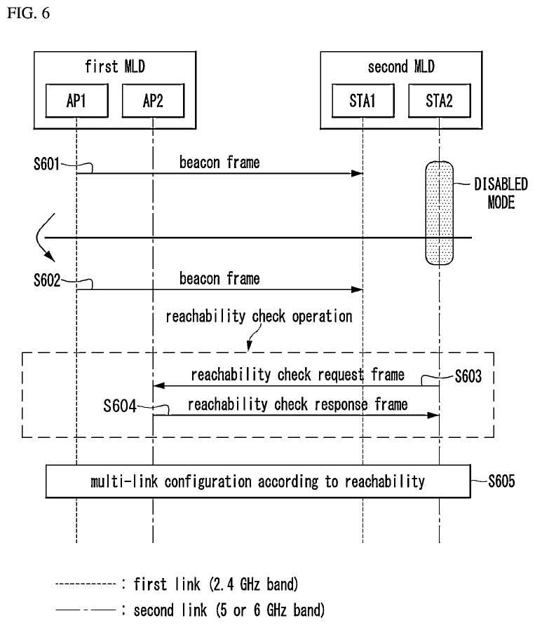

FIG. 6 is a sequence chart illustrating a second embodiment of a method for determining a link capable of communication in a wireless LAN system.

As shown in FIG. 6, a wireless LAN system may include a first MLD and a second MLD. The first MLD may be an AP MLD and may include an AP1 and an AP2. The second MLD may be a non-AP MLD and may include a STA1 and a STA2. Each of the AP1 and the STA1 may perform communication using a first link. A frequency band of the first link may be 2.4 GHz. Each of the AP2 and the STA2 may perform communication using a second link. A frequency band of the second link may be 5 GHz or 6 GHz.

The second MLD may be associated with the first MLD. In this case, the second MLD may operate in an associated state. The second MLD operating in the associated state may maintain a normal communication state with the first MLD. The AP1 may transmit a beacon frame in the first link (S601). The beacon frame transmitted in the first link may include information on a transmission power of the AP1 (e.g., AP of the current operating link), information on a beacon transmission power of a beacon frame of another AP (e.g., AP2 in the second link), and/or information on a difference between the transmission power of the beacon frame of the AP1 in the first link and the transmission power of the beacon frame of the AP2 in the second link. The information on the transmission power may be an EIRP value normalized to 20 MHz. The STA1 (e.g., STA1 maintaining the normal communication state) may perform a monitoring operation in the first link in order to receive a beacon frame. The STA1 may receive the beacon frame of the AP1 in the first link and identify the information included in the beacon frame.

The first MLD and/or the second MLD may move. Even when the first MLD and/or the second MLD moves, the associated state (e.g., normal communication state) between the first MLD and the second MLD may be maintained. The AP1 may transmit a beacon frame in the first link (S602). The beacon frame transmitted in the first link may include information on the transmission power of the beacon frame of the AP1 (e.g., AP of the current operating link), information on the transmission power of a beacon frame of another AP (e.g., AP2 in the second link), and/or information on a difference between the transmission power of the beacon frame of the AP1 in the first link and the transmission power of the beacon frame of the AP2 in the second link. The STA1 (e.g., STA1 maintaining the normal communication state) may perform a monitoring operation in the first link in order to receive a beacon frame. The STA1 may receive the beacon frame of the AP1 in the first link and may identify the information included in the beacon frame.

When a distance between the first MLD and the second MLD changes according to the movement of the first MLD and/or the second MLD or when a communication environment between the first MLD and the second MLD changes, a reception quality of the beacon frame received in the step S602 may be different from a reception quality of the beacon frame received in the step S601.

The second MLD may compare a reception signal quality (e.g., received signal strength, received signal strength indicator (RSSI), or effective radiated power (EIRP)) in the first link before the movement and a reception signal quality in the first link after the movement, and check availability of another link (e.g., second link) (e.g., reachability of signals in another link) based on a result of the comparison. After predicting the availability or the reachability of signals, the availability or reachability may be checked. In the method of predicting the availability or the reachability of signals, whether or not radio waves can be received according to a frequency (e.g., pathloss according to a channel model) may be identified by referring to the information on the transmission power of the beacon frame of the AP1 and a reception power of the first beacon frame. In other words, the availability of the link or the reachability of signals may be predicted by identifying whether radio waves can be received at a frequency used by the AP2 (e.g., pathloss according to a channel model). In embodiments, ‘availability’ may mean ‘reachability’.

For example, the second MLD may compare a reception quality of the beacon frame received in the step S601 and a reception quality (e.g., received signal strength) of the beacon frame received in the step S602. When the reception quality (e.g., received signal strength) of the beacon frame received in the step S602 is higher than the reception quality (e.g., received signal strength) of the beacon frame received in the step S601 or when the reception quality (e.g., received signal strength) of the beacon frame received in the step S602 is higher than (reception quality (e.g., received signal strength) of the beacon frame received in the step S601+offset), the second MLD may check availability of another link. The offset may be included in the beacon frame. Alternatively, when the reception quality (e.g., received signal strength) of the beacon frame received in the step S602 is lower than the reception quality (e.g., received signal strength) of the beacon frame received in the step S601 or when the reception quality (e.g., received signal strength) of the beacon frame received in the step S602 is lower than (reception quality (e.g., received signal strength) of the beacon frame received in the step S601+offset), the second MLD may check availability of another link.

Alternatively, when the link of the second MLD transitions from a low-power mode (e.g., power-saving mode) to a normal mode, an operation of checking availability of the corresponding link may be performed. A reception operation may not be performed in the low-power mode, and a normal communication state may be maintained in the normal mode.

Alternatively, the second MLD (e.g., STA1) may receive the beacon frame in the first link, may estimate (or measure) a pathloss based on the information on the transmission power included in the beacon frame received in the first link and a received signal strength of the beacon frame, and may perform an operation of checking availability of another link (e.g., second link) when the pathloss is less than a threshold or when the pathloss is equal to or greater than a threshold. In the case of another link having a shorter reach than the first link according to the frequency characteristics of the other link (e.g., second link), ‘when the pathloss is less than a threshold’ may mean that a reception state of signals is improved than before. This may mean that a previously unreachable signal may become reachable. ‘When the pathloss is greater than or equal to a threshold’ may mean that a reception state of signals is worse than before. This may mean that a previously reachable signal may become unreachable. If another link is determined to be available as a result of estimating a pathloss using information on a transmission power of a beacon frame of the other link that was previously unavailable, an operation of checking availability of another link (e.g., second link) may be performed. Even if another link is determined to be unavailable as a result of estimating a pathloss of the other link which was available, the operation of checking availability of another link (e.g., second link) may be performed. The operation of checking availability when assuming that another link is available may be performed when a beacon frame can be normally received in the other link. In other words, before performing the operation of checking availability, an operation of identifying whether a beacon frame can be normally received in another link may be performed.

The operation of checking availability (e.g., reachability) of the second link may be performed as follows. The STA2 may generate a reachability check request frame and may transmit the reachability check request frame in the second link (S603). The reachability check request frame may be a quality of service (QoS) null frame or a power saving (PS)-Poll frame. The AP2 may receive the reachability check request frame from the STA2 in the second link. When the reachability check request frame is received, the first MLD (e.g., AP2) may determine that a frame is reachable in the second link. In this case, the AP2 may transmit a reachability check response frame in the second link (S604). The reachability check response frame may indicate that the second link (e.g., the link through which the reachability check request/response frames are transmitted/received) is available. The reachability check response frame may be transmitted in the link through which the reachability check request frame was received. The reachability check response frame may be an ACK frame. The reachability check request frame may include a reception power of the beacon frame transmitted by the AP2 in the second link.

The operation of checking availability (e.g., reachability) may be performed when the second link is in the normal mode. When the second link is not used, the second link may be in the low-power mode (e.g., disabled mode). In order to perform the operation of checking availability, the operation mode of the second link may be transitioned from the low-power mode to the normal mode.

When the procedure of exchanging the reachability check request/response frames is successfully completed in the second link, the first MLD and the second MLD may determine that the second link is available. In this case, the first MLD and the second MLD may perform a multi-link (re)configuration procedure for configuring the second link in the first link and/or the second link (S605). In the step S605, a multi-link including the first link and the second link may be configured. The reachability check operation in the second link may be replaced by the multi-link (re)configuration procedure performed in the second link.

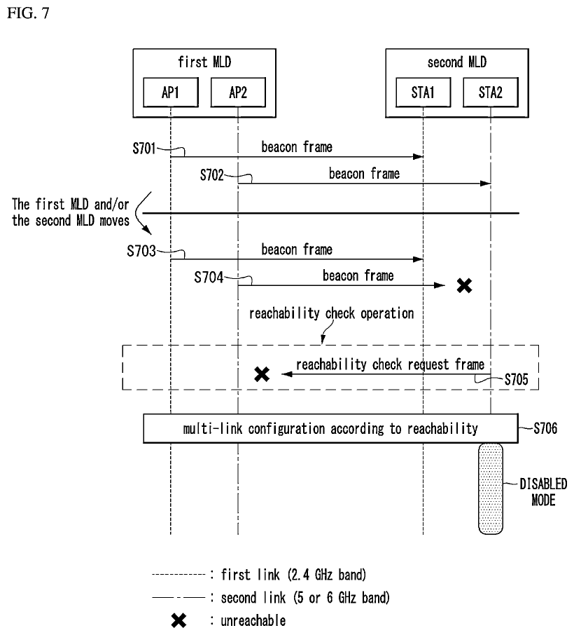

FIG. 7 is a sequence chart illustrating a third embodiment of a method for determining a link capable of communication in a wireless LAN system.

As shown in FIG. 7, a wireless LAN system may include a first MLD and a second MLD. The first MLD may be an AP MLD and may include an AP1 and an AP2. The second MLD may be a non-AP MLD and may include a STA1 and a STA2. Each of the AP1 and the STA1 may perform communication using a first link. A frequency band of the first link may be 2.4 GHz. Each of the AP2 and the STA2 may perform communication using a second link. A frequency band of the second link may be 5 GHz or 6 GHz.

The second MLD may be associated with the first MLD. In this case, the second MLD may operate in an associated state. The second MLD operating in the associated state may maintain a normal communication state with the first MLD. The AP1 may transmit a beacon frame in the first link (S701). The beacon frame transmitted in the first link may include information on a transmission power of the beacon frame of the AP1 (e.g., AP of the current operating link), information on a transmission power of a beacon frame of another AP (e.g., AP2 in the second link), and/or information on a difference the transmission power of the beacon frame of the AP1 in the first link and the transmission power of the beacon frame of the AP2 in the second link. The information on the transmission power may be an EIRP value normalized to 20 MHz. The STA1 (e.g., STA1 maintaining the normal communication state) may perform a monitoring operation in the first link in order to receive a beacon frame. The STA1 may receive the beacon frame of the AP1 in the first link and identify the information included in the beacon frame.

The AP2 may transmit a beacon frame in the second link (S702). The beacon frame transmitted in the second link may include information on a transmission power of the beacon frame of the AP2 (e.g., AP of the current operating link), information on a transmission power of a beacon frame of another AP (e.g., AP1 in the first link), and/or information on a difference between the transmission power of the beacon frame of the AP2 in the second link and the transmission power of the beacon frame of the AP1 in the first link. The STA2 (e.g., STA2 maintaining the normal communication state) may perform a monitoring operation in the second link in order to receive a beacon frame. The STA2 may receive the beacon frame of the AP2 in the second link and identify the information included in the beacon frame.

The first MLD and/or the second MLD may move. Even when the first MLD and/or the second MLD moves, the associated state (e.g., normal communication state) between the first MLD and the second MLD may be maintained. The AP1 may transmit a beacon frame in the first link (S703). The beacon frame transmitted in the first link may include information on the transmission power of the beacon frame of the AP1 (e.g., AP of the current operating link), information on a transmission power of a beacon frame of another AP (e.g., AP2 in the second link), and/or information on a difference between the transmission power of the beacon frame of the AP1 in the first link and the transmission power of the beacon frame of the AP2 in the second link. The STA1 (e.g., STA1 maintaining the normal communication state) may perform a monitoring operation in the first link in order to receive a beacon frame. The STA1 may receive the beacon frame of the AP1 in the first link and may identify the information included in the beacon frame.

When a distance between the first MLD and the second MLD changes according to the movement of the first MLD and/or the second MLD or when a communication environment between the first MLD and the second MLD changes, a reception quality of the beacon frame received in the step S703 may be different from a reception quality of the beacon frame received in the step S701.

The second MLD may compare a reception signal quality (e.g., received signal strength, RSSI, or EIRP) in the first link before the movement and a reception signal quality in the first link after the movement, and check availability of another link (e.g., second link) (e.g., reachability of signals in another link) based on a result of the comparison. After predicting the availability or the reachability of signals, the availability or reachability may be checked. In the method of predicting the availability or the reachability of signals, whether or not radio waves can be received according to a frequency (e.g., pathloss according to a channel model) may be identified by referring to the information on the transmission power of the beacon frame of the AP1 and a reception power of the first beacon frame. In other words, the availability of the link or the reachability of signals may be predicted by identifying whether radio waves can be received at a frequency used by the AP2 (e.g., pathloss according to a channel model).

For example, the second MLD may compare a reception quality of the beacon frame received in the step S701 and a reception quality (e.g., received signal strength) of the beacon frame received in the step S703. When the reception quality (e.g., received signal strength) of the beacon frame received in the step S703 is higher than the reception quality (e.g., received signal strength) of the beacon frame received in the step S701 or when the reception quality (e.g., received signal strength) of the beacon frame received in the step S703 is higher than (reception quality (e.g., received signal strength) of the beacon frame received in the step S701+offset), the second MLD may check availability of another link. The offset may be included in the beacon frame. Alternatively, when the reception quality (e.g., received signal strength) of the beacon frame received in the step S703 is lower than the reception quality (e.g., received signal strength) of the beacon frame received in the step S701 or when the reception quality (e.g., received signal strength) of the beacon frame received in the step S703 is lower than (reception quality (e.g., received signal strength) of the beacon frame received in the step S701+offset), the second MLD may check availability of another link.

Alternatively, the second MLD (e.g., STA1) may receive the beacon frame in the first link, may estimate (or measure) a pathloss based on the information on the transmission power included in the beacon frame received in the first link and a received signal strength of the beacon frame, and may perform an operation of checking availability of another link (e.g., second link) when the pathloss is less than a threshold or when the pathloss is equal to or greater than a threshold. In the case of another link having a shorter reach than the first link according to the frequency characteristics of the other link (e.g., second link), ‘when the pathloss is less than a threshold’ may mean that a reception state of signals is improved than before. This may mean that a previously unreachable signal may become reachable. ‘When the pathloss is greater than or equal to a threshold’ may mean that a reception state of signals is worse than before. This may mean that a previously reachable signal may become unreachable. If another link is determined to be unavailable as a result of estimating a pathloss using information on a transmission power of a beacon frame of the other link that was previously available, an operation of checking availability of another link (e.g., second link) may be performed. Even if another link is determined to be available as a result of estimating a pathloss of the other link which was unavailable, the operation of checking availability of another link (e.g., second link) may be performed. The operation of checking availability when assuming that another link is unavailable may be performed for clear checking when the beacon frame cannot be normally received in the other link. In other words, before performing the operation of checking availability, an operation of identifying whether a beacon frame can be normally received in another link may be performed.

The AP2 may transmit a beacon frame in the second link (S704). The beacon frame transmitted in the second link may include information on a transmission power of the beacon frame of the AP2 (e.g., AP of the current operating link), information on a transmission power of a beacon frame of another AP (e.g., AP1 in the first link), and/or information on a difference between the transmission power of the beacon frame of the AP2 and the transmission power of the beacon frame of the AP1. The STA2 (e.g., STA2 maintaining the normal communication state) may perform a monitoring operation in the second link in order to receive a beacon frame.

When a distance between the first MLD and the second MLD changes according to the movement of the first MLD and/or the second MLD or when a communication environment between the first MLD and the second MLD changes, in the step S704, the STA2 may not receive the beacon frame in the second link. In this case, the second MLD (e.g., STA2) may check availability (e.g., reachability) of the second link. When a frame (e.g., beacon frame) is not received n times in the second link, the second MLD (e.g., STA2) may check availability of the second link. Information indicating n may be included in a beacon frame received on another link (e.g., first link). Since the beacon frame transmitted in the other link (e.g., first link) includes information on a target beacon transmit time (TBTT) of the beacon frame to be transmitted in the second link, if the beacon frame is not transmitted at the TBTT, the beacon frame may be counted as not received.

The operation of checking availability (e.g., reachability) of the second link may be performed as follows. The STA2 may generate a reachability check request frame and may transmit the reachability check request frame in the second link (S705). The reachability check request frame may be a QoS null frame or a PS-Poll frame. If the reachability check request frame is not received in the second link, AP2 may not transmit a reachability check response frame, which is a response to the reachability check request frame, in the second link. Therefore, the STA2 may not receive the reachability check response frame within a preset period from a transmission time of the reachability check request frame. The reachability check response frame may be an ACK frame.

When the reachability check response frame is not received in the second link, the second MLD (e.g., STA2) may determine that communication is impossible in the second link. In this case, the first MLD and the second MLD may perform a multi-link (re)configuration procedure for releasing the second link (S706). The multi-link configured in the step S706 may not include the second link (e.g., second link in an unreachable state). When the second link is released, the second link may not be used. To save a power, the operation mode of the second link may transition from the normal mode to the low-power mode (e.g., disabled mode).

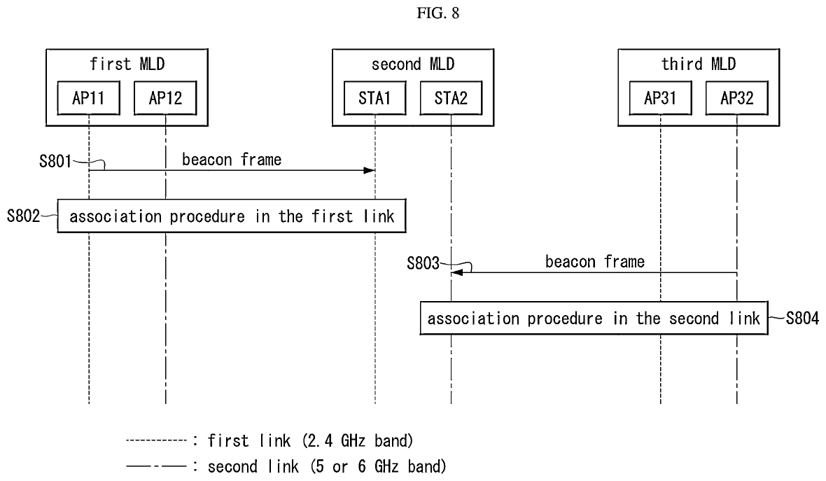

FIG. 8 is a sequence chart illustrating a first embodiment of an association method in a wireless LAN system.

As shown in FIG. 8, a wireless LAN system may include a first MLD, a second MLD, and a third MLD. The first MLD may be an AP MLD and may include an AP11 and an AP12. The second MLD may be a non-AP MLD and may include a STA1 and a STA2. The third MLD may be an AP MLD and may include an AP31 and an AP32. Each of the AP11, STA1, and AP31 may perform communication using a first link. A frequency band of the first link may be 2.4 GHz. Each of the AP12, STA2, and AP32 may perform communication using a second link. A frequency band of the second link may be 5 GHz or 6 GHz.

The AP11 may transmit a beacon frame in the first link (S801). The STA1 may receive the beacon frame from the AP11 by performing a monitoring operation in the first link. When the beacon frame is received, an association procedure may be performed between the AP11 and the STA1 (S802). When the association procedure is completed, the first MLD and the second MLD may operate in an associated state, and a normal communication state between the first MLD (e.g., AP11) and the second MLD (e.g., STA1) may be maintained.

Transmission distances of radio waves may be different according to frequency characteristics of the links (e.g., the first link and the second link). When the first link is available and the second link is unavailable, the association procedure between the first MLD and the second MLD may be performed using the first link.

The second MLD may perform a monitoring operation to discover another MLD (e.g., third MLD) in a link (e.g., second link) that is not configured with the first MLD. The AP32 may transmit a beacon frame in the second link (S803). When the beacon frame of the AP32 is received in the second link, an association procedure may be performed between the STA2 and the AP32 (S804). Alternatively, the step S804 may be performed when an operation of exchanging probe request/response frames is successfully completed instead of the operation of receiving the beacon frame. When the association procedure is completed, the second MLD and the third MLD may operate in the associated state, and a normal communication state may be maintained between the second MLD (e.g., STA2) and the third MLD (e.g., AP32).

In addition, the second MLD and the third MLD may perform communication using the first link. A channel of the first link between the second MLD and the third MLD may be different from a channel of the first link between the first MLD and the second MLD. In the frequency domain, the 2.4 GHz band may be divided into a plurality of channels, and the second MLD may change the channels so that the channel of the first link between the second MLD and the third MLD is different from the channel of the first link between the first MLD and the second MLD.

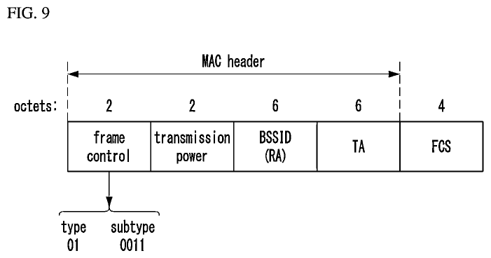

FIG. 9 is a block diagram illustrating a first embodiment of a reachability check request frame.

As shown in FIG. 9, a reachability check request frame (e.g., the reachability check request frame shown in FIGS. 6 and/or 7) may be used to check availability (e.g., reachability) of a link. The reachability check request frame may be a PS-Poll frame, or the reachability check request frame may have a form similar to that of a PS-Poll frame. For example, the reachability check request frame may include a transmission power (i.e., TX power) field instead of an association identifier (AID) field of the PS-Poll frame.

The reachability check request frame may include a frame control field, a transmission power field, a basic service set identifier (BSSID) field, a transmitter address (TA) field, and/or a frame check sequence (FCS) field. If [type: 01, subtype: 0011] is set in the frame control field, this may mean that the corresponding frame is the reachability check request frame (e.g., reachability check request frame in form of the PS-Poll frame). The transmission power field may indicate a transmission power of the reachability check request frame in link(s) supported by the MLD transmitting the reachability check request frame or a transmission power of the reachability check request frame in the link in which the reachability check request frame is transmitted. The TA field may indicate a MAC address of the MLD (e.g., AP or STA) transmitting the reachability check request frame.

An MLD (e.g., AP or STA) that has successfully received the reachability check request frame may transmit a reachability check response frame (e.g., ACK frame) in response to the reachability check request frame. The reachability check response frame may indicate that the current link (e.g., the link in which the reachability check request/response frame is transmitted/received) is available. If the transmission power indicated by the reachability check request frame is low, the MLD receiving the reachability check request frame may reconfigure a transmit power for the next transmission, and information indicating the reconfigured transmission power may be included in the reachability check response frame.

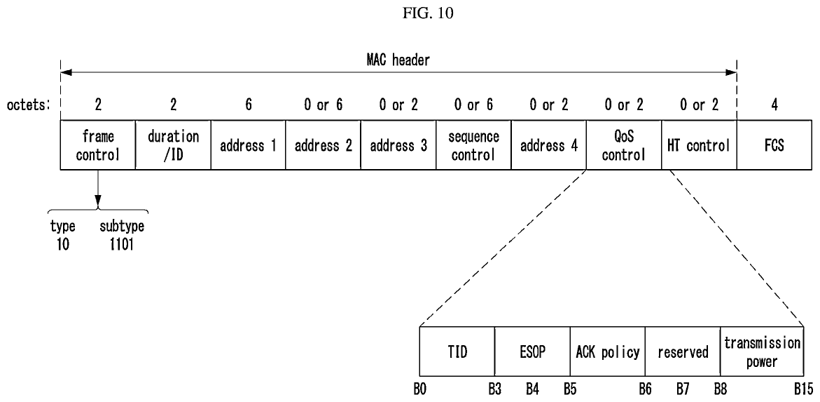

FIG. 10 is a block diagram illustrating a second embodiment of a reachability check request frame.

As shown in FIG. 10, a reachability check request frame (e.g., the reachability check request frame shown in FIGS. 6 and/or 7) may be used to check availability (e.g., reachability) of a link. The reachability check request frame may be a QoS null frame, or the reachability check request frame may have a form similar to that of a QoS null frame. The reachability check request frame may be a QoS null frame without data. However, parameter(s) included in a QoS control field of the reachability check request frame may be different from parameter(s) included in a QoS control field of the existing QoS null frame.

The reachability check request frame may include a frame control field, a duration/ID field, an address 1 field, an address 2 field, an address 3 field, a sequence control field, an address 4 field, a QoS control field, a high throughput (HT) control field, and/or an FCS field. If [type: 10, subtype: 1101] is set in the frame control field, this may mean that the corresponding frame is the reachability check request frame (e.g., reachability check request frame in form of a QoS null frame).

The QoS control field may include a TID field, an ESOP field, an ACK policy field, a reserved field, and/or a transmission power field. In the QoS control field, B8 to B15 may be configured as the transmission power field. The transmission power field may indicate a transmission power in link(s) supported by the MLD transmitting the reachability check request frame or a transmission power in the link in which the reachability check request frame is transmitted.

An MLD (e.g., AP or STA) that has successfully received the reachability check request frame may transmit a reachability check response frame (e.g., ACK frame) in response to the reachability check request frame. The reachability check response frame may indicate that the current link (e.g., the link in which the reachability check request/response frame is transmitted/received) is available. If the transmission power indicated by the reachability check request frame is low, the MLD receiving the reachability check request frame may reconfigure a transmit power for the next transmission, and information indicating the reconfigured transmission power may be included in the reachability check response frame.

Transmission distances of radio waves may vary according to frequency characteristics of the links. When the first link is configured in the 2.4 GHz band and the second link is configured in the 5 GHz band or the 6 GHz band, the transmission distance of radio waves in the second link may be shorter than the transmission distance of radio waves in the first link. When the same transmission power is used in the first link and the second link, communication may be possible in the first link, but communication may be impossible in the second link. To solve this problem, a transmission power (i.e., maximum transmission power) in each of the links may be set independently. For example, the (maximum) transmission power in the second link may be greater than the (maximum) transmission power in the first link.

Since interference may increase when the (maximum) transmission power is increased, a frame may be repeatedly transmitted instead of increasing the transmission power. The number of repeated transmissions (e.g., the maximum number of repeated transmissions) in each of the links may be set independently. For example, the number of repeated transmissions in the first link may be p, and the number of repeated transmissions in the second link may be k. Each of p and k may be a natural number. k may be greater than p. Alternatively, a frame may not be repeatedly transmitted in the first link.

A management frame, control frame, and/or data frame may include one or more information elements defined in Table 1 below. For example, one or more information elements defined in Table 1 may be included in the beacon frame and/or probe response frame shown in FIGS. 5 to 8.

TABLE 1

| Information element | Description |
|---|---|
| (Maximum) | The MLD (e.g., AP or STA) may use a |
| transmission power in | transmission power equal to or less |
| the first link | than the (maximum) transmission power |
| | in the first link (e.g., 2.4 GHz band). |
| (Maximum) | The MLD (e.g., AP or STA) may use a |
| transmission power in | transmission power equal to or less |
| the second link | than the (maximum) transmission power |
| | in the second link (e.g., 5 GHz or 6 GHz band). |
| The (maximum) number | The MLD (e.g., AP or STA) may repeatedly |
| p of repeated | transmit a frame a number of times equal |
| transmissions in the | to or less than p in the first link |
| first link | (e.g., 2.4 GHz band). |
| The (maximum) number | The MLD (e.g., AP or STA) may repeatedly |
| k of repeated | transmit a frame a number of times equal |
| transmissions in the | to or less than k in the second link |
| second link | (e.g., 5 GHz or 6 GHz band). |

When a multi-link including the first link and the second link is configured between the first MLD and the second MLD, communication in the multi-link may be performed based on one or more information elements defined in Table 1. Alternatively, in the embodiment shown in FIG. 5 or FIG. 7, if the second link is determined to be unreachable, the communication in the second link may be performed based on the (maximum) transmission power and/or the (maximum) number of repeated transmissions defined in Table 1. In other words, even when the second link is determined to be in an unreachable state, the second link may not be excluded from the multi-link configuration, and the communication in the second link may be performed based on the (maximum) transmission power and/or the (maximum) number of repeated transmissions defined in Table 1.

Repeated transmissions of a frame may be performed within a repeated transmission period, and the frame may be repeatedly transmitted according to a preset interval (e.g., xIFS). Information indicating the repeated transmission period and/or the preset interval may be included in Table 1.

The embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those having ordinary skill in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. An operation method of a first device in a communication system, the operation method comprising:
receiving a first beacon frame from a second device in a first link;
performing a monitoring operation in a second link to receive a second beacon frame from the second device; and
determining that the second link is in an unreachable state when the second beacon frame is not received in the second link,
wherein a first frequency band in which the first link is configured is different from a second frequency band in which the second link is configured, and a transmission distance of radio waves in the first frequency band is longer than a transmission distance of radio waves in the second frequency band.

2. The operation method according to claim 1, wherein the first beacon frame includes at least one of information indicating that the second link is available or information on a transmission power in the second link.

3. The operation method according to claim 1, further comprising: in response to determining that the second link is in the unreachable state,
transmitting a first probe request frame in the first link; and
transmitting a second probe request frame in the second link,
wherein the first probe request frame includes at least one of information indicating the first link in which the first probe request frame is transmitted or information indicating the second link in which the second probe request frame is transmitted.

4. The operation method according to claim 1, wherein the determining that the second link is in the unreachable state comprises:
transmitting a reachability check request frame in the second link; and
determining that the second link is in the unreachable state when a response frame to the reachability check request frame is not received in the second link.

5. The operation method according to claim 4, wherein the reachability check request frame has a form of a quality of service (QoS) null frame or a power saving (PS)-Poll frame.

6. The operation method according to claim 1, further comprising configuring a multi-link with the second device, the second link in the unreachable state being excluded from the multi-link.

7. The operation method according to claim 1, wherein each of the first beacon frame and the second beacon frame includes at least one of information on a maximum transmission power in the first link, information on a number of repeated transmissions in the first link, information on a maximum transmission power in the second link, information on a number of repeated transmissions in the second link, or combinations thereof.

8. The operation method according to claim 1, further comprising: in response to determining that the second link is in the unreachable state,
performing communication with the second device using a first transmission power in the first link; and
performing communication with the second device using a second transmission power in the second link,
wherein the second transmission power is greater than the first transmission power.

9. The operation method according to claim 1, further comprising: in response to determining that the second link is in the unreachable state,
performing communication with the second device in the first link without repeated transmissions of a frame; and
performing communication with the second device in the second link by repeatedly transmitting a frame.

10. An operation method of a first device in a communication system, the operation method comprising:
receiving a first beacon frame from a second device in a first link;
receiving a second beacon frame from the second device in the first link;
comparing a first reception quality of the first beacon frame with a second reception quality of the second beacon frame; and
performing a reachability check operation in a second link based on a result of the comparison between the first reception quality and the second reception quality.

11. The operation method according to claim 10, wherein each of the first beacon frame and the second beacon frame includes at least one of information on a transmission power in the first link, information on a transmission power in the second link, information on a difference between the transmission power in the first link and the transmission power in the second link, or combinations thereof.

12. The operation method according to claim 10, wherein the reachability check operation is performed when the second reception quality is higher than the first reception quality.

13. The operation method according to claim 10, wherein the reachability check operation is performed when the second reception quality is higher than the first reception quality plus an offset, wherein the offset is included in at least one of the first beacon frame and the second beacon frame.

14. The operation method according to claim 10, wherein the performing of the reachability check operation comprises:
transmitting a reachability check request frame in the second link;
receiving a reachability check response frame in the second link as a response to the reachability check request frame; and
determining that the second link is available when the reachability check response frame is received.

15. The operation method according to claim 14, further comprising configuring a multi-link including the available second link with the second device.

16. The operation method according to claim 14, wherein the reachability check request frame has a form of a quality of service (QoS) null frame or a power saving (PS)-Poll frame.

17. An operation method of a second device in a communication system, the operation method comprising:
generating a first frame including information indicating a number of repeated transmissions in a second link;
transmitting the first frame to a first device in a first link; and
in response to determining that a second frame is unreachable in the second link, repeatedly transmitting the second frame to the first device in the second link as many times as the number of repeated transmissions indicated by the first frame.

18. The operation method according to claim 17, further comprising, when a third frame is reachable in the first link, transmitting the third frame to the first device in the first link without repeated transmissions.

19. The operation method according to claim 17, wherein the first frame further includes information indicating a second transmission power in the second link, and the second frame is transmitted using the second transmission power indicated by the first frame.

20. The operation method according to claim 19, wherein the first frame further includes information indicating a first transmission power in the first link, wherein the first transmission power is lower than the second transmission power.
